(19) United States
(12) Patent Application Publication
(10) Pub. No.: US 2022/0376560 A1
(43) Pub. Date: Nov. 24, 2022

(54) Method for Wirelessly Transmitting Electric Energy, Energy Transmitting Device, and System Consisting of Energy Transmitting Devices

(71) Applicant: Robert Bosch GmbH, Stuttgart (DE)

(72) Inventors: Martin Gonda, Buehl (DE); Dragan Krupezevic, Stuttgart (DE)

(21) Appl. No.: 17/753,767

(22) PCT Filed: Aug. 4, 2020
(86) PCT No.: PCT/EP2020/071897

§ 371 Date: Mar. 14, 2022

(30) Foreign Application Priority Data
Sep. 16, 2019 (DE) 10 2019 214 047.5

(51) Int. Cl. H02J 50/60; H02J 50/12; H02J 50/80; H02J 7/00

(52) U.S. Cl. CPC H02J 50/60; H02J 50/12; H02J 50/80; H02J 7/00036

(57) ABSTRACT

A method for wirelessly transmitting electric energy to an energy receiving device using at least one energy transmitting device, in particular an induction transmission device. The method includes wirelessly transmitting electric energy to the energy receiving device via at least one voltage signal using at least one resonant circuit of the at least one energy transmitting device, and pausing the transmission of the at least one voltage signal, in particular at regular intervals, in order to detect foreign bodies and/or for communication between the at least one energy transmitting device and the energy receiving device and/or an external unit. The method further includes ascertaining over time at least one point in time of the transmission pauses of the at least one voltage signal on the basis of at least one external reference signal, in particular a reference signal which is independent of the energy receiving device, using at least one control and/or regulating unit of the at least one energy transmitting device.

### PRIOR ART

A method for wirelessly transmitting electrical energy to at least one energy transmission device has already been proposed, wherein, in at least one method step, electrical energy is wirelessly transmitted to the energy reception device by way of at least one oscillating circuit of the energy transmission device using at least one voltage signal, and wherein, in at least one method step, transmission pauses of the voltage signal take place in order to detect foreign bodies and/or to allow the energy transmission device to communicate with the energy reception device and/or with an external unit.

### DISCLOSURE OF THE INVENTION

The invention is based on a method for wirelessly transmitting electrical energy to an energy reception device, in particular in order to charge a rechargeable battery, by way of at least one energy transmission device, in particular an induction transmission device, wherein, in at least one method step, electrical energy is wirelessly transmitted to the energy reception device by way of at least one oscillating circuit of the energy transmission device using at least one voltage signal, and wherein, in at least one method step, in particular at regular time intervals, transmission pauses of the voltage signal take place in order to detect foreign bodies and/or to allow the energy transmission device to communicate with the energy reception device and/or with an external unit.

It is proposed, in at least one method step, for at least one time of the transmission pauses of the voltage signal to be temporally ascertained on the basis of at least one external reference signal, which is in particular independent of the energy reception device, by way of at least one control and/or regulation unit of the energy transmission device.

The external reference signal is particularly preferably in the form of a grid voltage, in particular of a supply grid connected to the energy transmission device, or of a signal, in particular a magnetic alternating field or an electromagnetic signal, from an external device, which is arranged in particular in the vicinity of the energy transmission device. The time of the transmission pauses is preferably ascertained on the basis of at least one signal characteristic variable, in particular a time of a zero crossing, an amplitude, a time of a maximum, a time of a minimum, a frequency, a wavelength or the like of the external reference signal. In particular, in at least one method step, the repetition rate of the transmission pauses is determined by way of the control and/or regulation unit, in particular on the basis of the grid voltage, the energy transmission device and/or the energy reception device. The repetition rate of the transmission pauses preferably corresponds to a value from a range of values of in particular 40 Hz to 200 Hz, preferably 60 Hz to 150 Hz and particularly preferably 100 Hz to 120 Hz. It is conceivable for the repetition rate of the transmission pauses to be kept constant by way of the control and/or regulation unit during a transmission process. In particular, electrical energy is transmitted from the energy transmission device to the energy reception device during the transmission process. Preferably, the time of the transmission pauses is temporally ascertained before a beginning of a transmission process and/or during a transmission process. The method is particularly preferably intended to synchronize transmission pauses of more than one energy transmission device with one another, in particular by way of the external reference signal. “Intended” should in particular be understood to mean specifically designed. The fact that a method is intended for a particular function should in particular be understood to mean that this particular function is implemented in at least one method step of the method.

In particular, in at least one method step, the oscillating circuit is excited so as to transmit energy via at least one control signal by way of a control circuit of the energy transmission device. Preferably, in at least one method step, the control signal for exciting the oscillating circuit is generated by way of the control and/or regulation unit. The control signal in particular has a control frequency, which corresponds in particular to a resonant frequency of the system consisting of energy reception device and energy transmission device. However, other configurations of the control signal, in particular the control frequency, are also conceivable. In particular, the control signal is in the form, in particular at least roughly, of at least one rectangular-wave signal and/or of a rectangular oscillation. The energy transmission device, in particular the control circuit, is preferably operated and/or excited at, in particular by way of, the grid voltage of the external supply grid. Particularly preferably, the grid voltage is in the form of an AC voltage or of a DC voltage. In particular in a configuration of the grid voltage as AC voltage, the grid voltage is preferably rectified by way of a rectifier of the energy transmission device, in particular upstream of the control circuit in terms of circuitry, so as to excite the oscillating circuit. The oscillating circuit preferably oscillates at the resonant frequency following excitation, with in particular a free or forced electrical oscillation taking place. The energy transmission device, in particular the control circuit and/or the oscillating circuit, is in particular designed such that an amplitude of the voltage signal at at least one time, in particular upon a rising edge of the control signal, is proportional to an amplitude of a voltage, in particular the voltage supplying the control circuit and/or present at the control circuit, in particular the preferably rectified AC voltage or DC voltage at that time. The voltage signal preferably has a frequency that corresponds in particular to at least 1 kHz, preferably at least 10 kHz and particularly preferably at least 80 kHz. The frequency of the voltage signal preferably corresponds at least substantially to the resonant frequency of the system consisting of energy reception device and energy transmission device. The control circuit is particularly preferably designed to apply a voltage, in particular the preferably rectified AC voltage or the DC voltage, to the oscillating circuit on the basis of the control signal, in particular to excite the oscillating circuit with the voltage. “Designed” should in particular be understood to mean specifically programmed, specifically configured and/or specifically equipped. The fact that an object is designed for a certain function should in particular be understood to mean that the object fulfils and/or implements this particular function in at least one application state and/or operating state. The control circuit is in particular designed such that, in the event of a limit value of the control signal being exceeded, the voltage, in particular the preferably rectified AC voltage or the DC voltage, is applied to the oscillating circuit and/or the oscillating circuit is excited with the voltage. In particular, in one configuration of the control signal as rectangular-wave signal and/or as rectangular oscillation, the limit value of the control signal is preferably greater than an arithmetic mean of an amplitude of the control signal, in particular considered over a period of the control signal. A magnetic alternating field is preferably generated by way of the oscillating circuit using the voltage signal, which magnetic alternating field induces at least one current in a receiver coil of the energy reception device in order to transmit the electrical energy.

Preferably, during the transmission pauses, at least one foreign body identification is performed by way of the energy transmission device, in particular a detection unit of the energy transmission device. The foreign body identification is preferably performed within a gap between the energy transmission device, in particular a transmission coil of the energy transmission device, and the energy reception device, in particular a receiver coil of the energy reception device. The foreign body identification is preferably performed by way of the detection unit by determining and/or calculating at least one quality characteristic value, in particular a quality, of the oscillating circuit and/or of a transmission system consisting of oscillating circuit and energy reception device, wherein the determined and/or calculated quality characteristic value of the oscillating circuit and/or of the transmission system consisting of oscillating circuit and energy reception device is in particular compared with at least one reference quality characteristic value. The reference quality characteristic value is in particular a quality characteristic value of the oscillating circuit and/or of the transmission system consisting of oscillating circuit and energy reception device in the absence of any foreign body. By way of example, in the presence of any foreign body in the gap, a quality characteristic value of the oscillating circuit that is lower than the reference quality characteristic value is determined. The foreign body identification preferably takes place in accordance with at least one standard, in particular the QI standard, from the Wireless Power Consortium (WPC).

At least one data transmission preferably takes place during the transmission pauses by way of the energy transmission device, in particular a communication unit of the energy transmission device. The data transmission in particular takes place between the energy transmission device and the energy reception device and/or an external unit, for example another energy transmission device. Electronic data are preferably transmitted for the data transmission. By way of example, the communication unit is designed to communicate a state, in particular a state of charge, of the energy reception device to the energy transmission device via the data transmission. As an alternative or in addition, it is conceivable for the communication unit to be designed to communicate a state of the energy reception device and/or of the energy transmission device to an external unit, such as for example a server, a monitoring unit and/or another energy transmission device, via the data transmission. Preferably, in at least one method step, a duration of the transmission pauses is determined on the basis of the energy transmission device, in particular the detection unit and/or the communication unit, and/or the energy reception device. The duration of the transmission pauses in particular corresponds to a value from a range of values of in particular 0.1 ms to 3 ms, preferably 0.5 ms to 2 ms and particularly preferably 1 ms to 1.5 ms, particularly advantageously preferably of 1.2 ms. The data transmission preferably takes place in accordance with at least one standard, in particular the QI standard, from the Wireless Power Consortium (WPC).

The configuration according to the invention of the method allows advantageously simple and fast synchronization of transmission pauses of multiple energy transmission devices, in particular advantageously independently of any connection between the energy transmission devices. Synchronizing transmission pauses makes it possible to achieve an advantageously reliable data transmission. Synchronizing transmission pauses allows advantageously accurate foreign body identification, in particular undisrupted by interference caused by electromagnetic fields of other energy transmission devices in the vicinity of the energy transmission device. Simultaneous operation of a multiplicity of energy transmission devices in a constricted space, for example in a kitchen, may advantageously be made possible, in particular since foreign bodies may be identified and/or data may be transmitted by the energy transmission devices advantageously at the same time, and thereby unimpacted by voltage signals for transmitting electrical energy to energy reception devices.

It is furthermore proposed, in at least one method step, for the voltage signal to be adapted by way of the control and/or regulation unit on the basis of the ascertained time of the transmission pauses. Preferably, at the ascertained time of the transmission pauses of the voltage signal, excitation of the oscillating circuit is suspended over a duration of the transmission pauses by way of the control circuit and/or the control and/or regulation unit. It is conceivable for the voltage signal in the oscillating circuit to be damped at the ascertained time of the transmission pauses. The voltage signal is preferably adapted by way of the control and/or regulation unit such that an amplitude of the voltage signal in the transmission pauses is reduced in comparison with a transmission process outside the transmission pauses. A transmission of energy from the energy transmission device to the energy reception device is in particular at least substantially suspended at the ascertained time of the transmission pauses by way of the control and/or regulation unit, in particular by suspending the excitation of the oscillating circuit and/or damping the voltage signal in the oscillating circuit. By way of example, at the ascertained time of the transmission pauses, excitation of the oscillating circuit by the control circuit is suspended by way of the control and/or regulation unit. As an alternative or in addition, it is conceivable for the oscillating circuit to be damped at the ascertained time of the transmission pauses, in particular by introducing an electrical resistance into the oscillating circuit. Advantageously simple and fast synchronization of voltage signals is able to be achieved. An advantageously high energy transmission from the energy transmission device to the energy reception device is able to be achieved, in particular since the majority of an energy transmission is able to take place through the voltage signal in the oscillating circuit within time intervals outside the transmission pauses.

It is additionally proposed, in at least one method step, for at least one temporal profile of the external reference signal to be detected and processed by way of the control and/or regulation unit in order to ascertain the time of the transmission pauses of the voltage signal. The temporal profile of the external reference signal is preferably detected by way of the control and/or regulation unit using at least one signal characteristic variable, in particular an amplitude, a frequency and/or a wavelength, of the voltage signal, wherein the external reference signal in particular influences the signal characteristic variable of the voltage signal. The signal characteristic variable is preferably detected and plotted over at least one time interval in order to detect the temporal profile of the external reference signal. The time interval is particularly preferably in the form of a transmission pause of the voltage signal. As an alternative or in addition, it is conceivable for the temporal profile of the external reference signal to be detected by way of at least one sensor unit of the energy transmission device and transmitted to the control and/or regulation unit. In particular in a configuration of the method in which the external reference signal is in the form of a grid voltage, the external reference signal is preferably detected directly via the control and/or regulation unit, wherein in particular the grid voltage present at the energy transmission device, in particular at the control and/or regulation unit and/or the control circuit, is detected. The temporal profile of the external reference signal for ascertaining the time of the transmission pauses of the voltage signal particularly preferably comprises at least one period length of the external reference signal. When processing the temporal profile in order to ascertain the time of the transmission pauses of the voltage signal, at least one time of a minimum of the temporal profile is preferably determined by way of the control and/or regulation unit. The voltage signal is in particular adapted by way of the control and/or regulation unit such that the transmission pauses temporally comprise the time of the minimum of the temporal profile of the external reference signal. Interference by the reference signal with the foreign body identification and/or the data transmission may advantageously be prevented during the transmission pauses. The time of the transmission pauses of the voltage signal is advantageously able to be ascertained quickly and easily, in particular since it is possible to ascertain and process the temporal profile of the external reference signal directly by way of the control and/or regulation unit. An advantageously compact energy transmission device may be made possible, in particular since an additional sensor unit is able to be dispensed with. Advantageously fast and simple synchronization of transmission pauses of multiple energy transmission devices may be made possible.

It is furthermore proposed for the external reference signal to be in the form of a time of a minimum or of a maximum of an, in particular the abovementioned preferably rectified, AC voltage of a supply grid of the energy transmission device. The time of the transmission pauses of the voltage signal is in particular ascertained on the basis of the at least one time of the minimum or the maximum of the AC voltage. The voltage signal is preferably adapted by way of the control and/or regulation unit such that the transmission pauses temporally comprise the time of the minimum of the AC voltage, in particular a zero crossing of the grid voltage. The grid voltage, in the form of an AC voltage, in at least one method step, is in particular rectified by way of the energy transmission device, in particular the rectifier of the energy transmission device, wherein the minimum of the rectified AC voltage is in the form of a zero crossing of the AC voltage, in particular of grid voltage. In at least one method step, exactly one external conductor, in particular one phase, of the supply grid is preferably selected by way of the control and/or regulation unit for ascertaining the time of the transmission pauses and for exciting the oscillating circuit and/or predefined for ascertaining the time of the transmission pauses and for exciting the oscillating circuit when the energy transmission device is manufactured. The voltage signal is in particular adapted by way of the control and/or regulation unit such that the time of the minimum of the in particular rectified AC voltage is arranged temporally at least substantially centrally within the ascertained time of the transmission pauses, wherein in particular the time of the minimum is temporally arranged in particular at least 40%, preferably at least 45% and particularly preferably at least 48% of an overall duration of the transmission pauses in each case after a beginning of the transmission pauses. The voltage signal is preferably adapted by way of the control and/or regulation unit such that the time of the minimum is temporally arranged in particular at least 40%, preferably at least 45% and particularly preferably at least 48% of an overall duration of the transmission pauses in each case before an end of the transmission pauses. Advantageously simple and fast synchronization of transmission pauses of energy transmission devices operated with an AC voltage may be made possible. An advantageously low energy loss in a transmission process may be made possible, in particular since the transmission pauses may take place within a time interval in which an energy transmission of the oscillating circuit is at a minimum.

It is furthermore proposed for the external reference signal to be in the form of an interference signal that is overlaid on the voltage signal. By way of example, the interference signal is in the form of a magnetic alternating field, which induces an electric current in the oscillating circuit in particular when it passes through the transmission coil of the energy transmission device. It is in particular conceivable for the interference signal to be in the form of a signal from another transmission coil of another energy transmission device, wherein electrical energy is in particular transmitted to another energy reception device. A current is preferably induced in the oscillating circuit by the interference signal. The at least one signal characteristic variable, in particular the amplitude, the frequency and/or the wavelength, of the voltage signal is preferably changed by the interference signal. Foreign body identification and/or data transmission by the energy transmission device, in particular the detection unit and/or the communication unit, is in particular interrupted and/or disrupted during the transmission pauses by way of a change in the signal characteristic variable, in particular by the external reference signal in the form of an interference signal. The interference signal particularly preferably changes the quality characteristic value of the oscillating circuit and/or of the transmission system consisting of oscillating circuit and energy reception device. The time of the transmission pauses may advantageously be adapted to interfering factors influencing the oscillating circuit, such as for example electrical or magnetic fields of other devices in the vicinity of the energy transmission device. Nearby energy transmission devices may advantageously be synchronized by the oscillating circuit, in particular the transmission coil. Interference with foreign body identification and/or data transmission may advantageously be prevented, in particular since the foreign body identification and/or the data transmission take/takes place during the transmission pauses and may take place on the basis of the quality characteristic value of the oscillating circuit and/or of the transmission system consisting of oscillating circuit and energy reception device.

It is additionally proposed, in at least one method step, for the external reference signal, in particular in the form of an interference signal, to be detected by way of the control and/or regulation unit during the transmission pauses of the voltage signal. The external reference signal in the form of an interference signal is preferably detected continuously or periodically by way of the control and/or regulation unit during the transmission pauses of the voltage signal and stored in at least one storage unit. The external reference signal in the form of an interference signal is preferably detected by evaluating the voltage signal by way of the control and/or regulation unit in terms of changes in the signal characteristic variable or the quality characteristic value of the voltage signal, in particular during the transmission pauses. By way of example, the control and/or regulation unit compares signal characteristic variables or quality characteristic values of the voltage signal in successive transmission pauses in order to identify changes in the voltage signal that are brought about by the interference signal overlaid on the voltage signal. Advantageously direct and fast detection and/or identification of the reference signal in the form of an interference signal may be made possible.

It is furthermore proposed, in at least one method step, for the external reference signal, in particular in the form of an interference signal, to be detected by way of the control and/or regulation unit through a comparison of the voltage signal with at least one reference pattern. The reference pattern is preferably detected in at least one method step, in particular independently of an interference signal, and stored in the control and/or regulation unit, in particular the storage unit. The reference pattern is preferably in the form of a voltage signal during a transmission pause. It is conceivable for a multiplicity of reference patterns to be stored in the control and/or regulation unit, wherein each reference pattern is assigned at least one state characteristic variable, in particular an electrical energy, a voltage or the like, of the oscillating circuit and/or a duration of the transmission pauses. The reference pattern for the comparison with the voltage signal is preferably selected from the multiplicity of stored reference patterns by way of the control and/or regulation unit on the basis of the duration of the transmission pauses of the voltage signal and/or of the state characteristic variable of the oscillating circuit generating the voltage signal, wherein the duration of the transmission pauses and the state characteristic variable of the oscillating circuit in particular at least substantially match the duration, assigned to the reference pattern, of the transmission pauses and/or the state characteristic variable, assigned to the reference pattern, of the oscillating circuit. If the voltage signal differs from the reference pattern during the transmission pauses, an interference signal is detected, wherein in particular a deviation of the voltage signal from the reference signal is ascertained. It is advantageously possible to detect and/or identify the external reference pattern in the form of an interference signal only within a transmission pause. Advantageously fast and simple adaptation of the time of the transmission pauses may be achieved.

It is furthermore proposed, in at least one method step, to detect the external reference signal, in particular in the form of an interference signal, by way of the control and/or regulation unit through a comparison of quality characteristic values, determined and/or calculated by way of the control and/or regulation unit, of the oscillating circuit during at least two in particular successive transmission pauses of the voltage signal. The quality characteristic values of the oscillating circuit are preferably compared with one another by way of the control and/or regulation unit in order to detect the external reference signal, wherein an interference signal is detected in particular in the event of a temporal change in the quality characteristic value. The external reference signal is particularly preferably detected in at least one calibration mode of the energy transmission device, wherein in particular the gap is free of foreign bodies. It is conceivable for the calibration mode to be activated automatically when the energy transmission device is switched on and/or to be able to be activated by a user of the energy transmission device, wherein a query is made, preferably by way of the control and/or regulation unit and/or by way of an input and/or output unit of the energy transmission device, as to whether the gap is free of foreign bodies. As an alternative or in addition, it is conceivable for an, in particular the abovementioned, temporal profile of the external reference signal to be detected by way of a quality characteristic value, detected by way of the control and/or regulation unit and/or by way of a sensor unit of the energy transmission device, of the oscillating circuit and/or of the transmission system consisting of oscillating circuit and energy reception device. The transmission pauses are preferably time-shifted in increments in order to detect the temporal profile of the external reference signal and the quality characteristic value is plotted over the time shift of the transmission pauses. During the processing of the temporal profile of the external reference signal in order to ascertain the time of the transmission pauses of the voltage signal, at least one time of a maximum of the temporal profile of the quality characteristic value is preferably determined by way of the control and/or regulation unit using the quality characteristic value. The voltage signal is in particular adapted by way of the control and/or regulation unit such that the transmission pauses temporally comprise the time of the maximum of the temporal profile of the quality characteristic value. It is advantageously possible to detect the external reference signal in the form of an interference signal independently of reference data, in particular of the voltage signal. Advantageously high flexibility of the method is able to be achieved, in particular since predefined or stored limit values may be dispensed with.

It is additionally proposed, in at least one method step, for the voltage signal to be adapted, in particular time-shifted, by way of the control and/or regulation unit, in particular using at least one algorithm, such that the time of the transmission pauses of the voltage signal corresponds at least substantially to a time of a minimum of the interference signal. The algorithm is preferably executed at least by way of the control and/or regulation unit. The transmission pauses are preferably time-shifted in increments by way of the algorithm, in particular by the control and/or regulation unit and at least one characteristic variable of the voltage signal, in particular the deviation of the voltage signal from the reference signal, is detected. Preferably, following a time shift of the transmission pauses, which time shift corresponds to at least one period duration of the voltage signal, the characteristic variable of the voltage signal, in particular the deviation of the voltage signal from the reference signal, is plotted following the time shift of the transmission pauses, wherein at least one minimum of the characteristic variable of the voltage signal, in particular the deviation of the voltage signal from the reference signal, is in particular ascertained by way of the control and/or regulation unit. The voltage signal is preferably adapted by way of the control and/or regulation unit such that the transmission pauses comprise a time of the minimum of the characteristic variable of the voltage signal, in particular the deviation of the voltage signal from the reference signal. Preferably, in at least one method step, in particular after the minimum of the characteristic variable of the voltage signal has been determined by the algorithm, at least one synchronization signal is output to at least one further energy transmission device in the vicinity of the energy transmission device, preferably by way of the communication unit. The communication unit is preferably designed to convey the ascertained time of the transmission pauses to the further energy transmission device using the synchronization signal and/or to signal an end of a run-through of the algorithm of the energy transmission device. As an alternative or in addition, it is conceivable to apply a standard deviation of a foreign body identification and/or a measurement of the detection unit in order to ascertain the interference signal, in particular during the transmission pauses, by way of the algorithm. An advantageously flexible adaptation of the time of the transmission pauses of the voltage signal may be achieved, in particular since an optimum time in relation to the surroundings of the energy transmission device is able to be ascertained using the algorithm. It is possible to ascertain a time of the transmission pauses at which the voltage signal is overlaid by an advantageously small interference signal. The algorithm in particular allows advantageously effective synchronization of energy transmission devices in a region, in particular independently of any direct communication between the energy transmission devices.

It is furthermore proposed, in at least one method step, for the ascertained time of the transmission pauses of the voltage signal to be synchronized with at least one external unit, in particular another energy transmission device, by way of at least one, in particular the abovementioned or a further, communication unit of the energy transmission device. The energy transmission device is preferably synchronized with the external unit via NFC, Bluetooth, W-LAN, PLC or the like. In particular, in at least one method step, a communication request is output to external units located in the vicinity of the energy transmission device, in particular other energy transmission devices, by way of the communication unit, in particular periodically or continuously, in particular in order to synchronize transmission pauses. It is conceivable for the vicinity of the energy transmission device to extend over a region within which the voltage signal is influenced significantly by electrical and/or magnetic fields, in particular by other external units known to a person skilled in the art, such as for example other energy transmission devices known to a person skilled in the art. As an alternative or in addition, it is also conceivable for the vicinity of the energy transmission device to be in the form of a volume of a space, in particular of a building, in which the energy transmission device is arranged. Preferably, in order to synchronize the energy transmission device with the external unit, the duration and the repetition rate of the transmission pauses of the voltage signal are transmitted to the external unit by way of the communication unit. In particular in a configuration of the method in which the time of the transmission pauses of the voltage signal is ascertained using the grid voltage of the supply grid, an external conductor, connected to the energy transmission device and/or used to ascertain the time of the transmission pauses of the voltage signal, of the supply grid is preferably transmitted to the external unit by way of the communication unit in order to synchronize the energy transmission device with the external unit. As an alternative or in addition, it is conceivable, in particular if the external unit is operated independently of an AC voltage, for example with a DC voltage, for the ascertained time of the transmission pauses of the voltage signal to be transmitted to the external unit by way of the communication unit. In particular if the external unit is in the form of another energy transmission device, transmission pauses of the external unit and of the energy transmission device are synchronized via the communication unit. Advantageously fast and direct synchronization of transmission pauses of mutually compatible devices is able to be achieved.

Also proposed is an energy transmission device, in particular an induction transmission device, for performing a method according to the invention for wirelessly transmitting electrical energy to an energy reception device, in particular in order to charge a rechargeable battery.

The energy transmission device is preferably in the form of an induction transmission device or of an induction charger. The external reference signal is preferably formed independently of the energy transmission device and the energy reception device, wherein the external reference signal is in particular generated in an external unit other than the energy transmission device and the energy reception device. The energy reception device and/or the energy transmission device are/is in particular in the form of smart kitchen devices. The energy transmission device preferably has the control circuit and the control and/or regulation unit. A “control and/or regulation unit” should in particular be understood to mean a unit having at least one set of control electronics. “Control electronics” should in particular be understood to mean a unit having a processing unit and having an, in particular the abovementioned, storage unit and having an operating program stored in the storage unit. The energy transmission device preferably has the oscillating circuit that comprises the transmission coil, at least one capacitor and at least one electrical resistor, wherein the electrical resistor is in particular in the form of an electrical resistance of line elements of the oscillating circuit. The control circuit is in particular electrically connected to the control and/or regulation unit and the oscillating circuit. The control circuit preferably comprises at least one driver element and at least one further driver element. However, it is also conceivable for the control circuit to comprise just one driver element. The driver element, in particular in relation to the oscillating circuit, is preferably in the form of a high-side driver and the further driver element, in particular in relation to the oscillating circuit, is in the form of a low-side driver. The driver element and/or the further driver element are/is in particular in the form of one or more metal oxide semiconductor field-effect transistors, in particular so-called MOSFETs, or in the form of one or more insulated-gate bipolar transistors, in particular so-called IGBTs. The driver elements are preferably designed to be switched by way of the control and/or regulation unit, in particular using the control signal. The oscillating circuit is preferably designed to be excited with the grid voltage by way of the control circuit using the control signal. The energy transmission device, in particular the oscillating circuit, is in particular designed to wirelessly transmit electrical energy to the energy reception device using the voltage signal. The energy transmission device, in particular the control and/or regulation unit, is preferably designed to generate transmission pauses in the voltage signal, in particular at regular time intervals, wherein in particular the transmission pauses of the voltage signal are intended to allow detection of foreign bodies and/or to allow the energy transmission device to communicate with the energy reception device and/or with the external unit. The energy transmission device, in particular the control and/or regulation unit, is particularly preferably designed to temporally ascertain the at least one time of the transmission pauses of the voltage signal on the basis of at least the external reference signal, which is in particular independent of the energy reception device. The energy transmission device preferably has the detection unit and/or the communication unit, which are/is in particular connected to the control and/or regulation unit. The energy transmission device is particularly preferably designed to synchronize the time of the transmission pauses with the external unit, in particular a further energy transmission device, using the external reference signal and/or using the communication unit. The energy transmission device preferably comprises at least one device receptacle that is designed to at least partially receive the energy reception device in a transmission process. The device receptacle preferably at least partially defines the gap in the at least one operating state. The transmission coil and/or the detection unit is in particular arranged in the device receptacle.

The configuration according to the invention of the energy transmission device allows advantageously simple and fast synchronization of transmission pauses of multiple energy transmission devices, in particular advantageously independently of any connection between the energy transmission devices. Synchronizing transmission pauses makes it possible to achieve an advantageously reliable data transmission. Synchronizing transmission pauses allows advantageously accurate foreign body identification, in particular undisrupted by interference caused by electromagnetic fields of other energy transmission devices in the vicinity of the energy transmission device. Simultaneous operation of a multiplicity of energy transmission devices in a constrained space, for example in a kitchen, may advantageously be made possible, in particular since foreign bodies may be identified and/or data may be transmitted by the energy transmission devices advantageously at the same time, and thereby unimpacted by voltage signals for transmitting electrical energy to energy reception devices. Transmission pauses of a multiplicity of energy transmission devices may advantageously be synchronized independently of any physical and/or wired connection of the energy transmission devices.

Also proposed is a system consisting of at least more than one energy transmission device according to the invention, in particular one induction transmission device, wherein transmission pauses of voltage signals of the energy transmission devices are temporally synchronized, in particular on the basis of at least one, in particular the abovementioned, external reference signal. In particular in a configuration of the external reference signal as AC current of the supply grid, the transmission pauses of the voltage signals of the energy transmission devices are preferably synchronized using the same external conductor of the supply grid that is used to ascertain the time of the transmission pauses. All of the energy transmission devices of the system are preferably connected to exactly one external conductor of the supply grid. All of the energy transmission devices of the system are preferably connected to the same external conductor of the supply grid, wherein in particular the times of the minimum or of the maximum of the AC voltage of the supply grid are the same for all energy transmission devices. In particular in a configuration of the external reference signal as an interference signal, the transmission pauses of the voltage signals of the energy transmission devices are preferably each synchronized by executing the algorithm when each of the energy transmission devices is put into service, wherein the interference signal is in particular preferably in the form of magnetic alternating fields of transmission coils of energy transmission devices that are already in operation at the time of putting into service. The algorithm is in particular designed to synchronize a time of the transmission pauses of the voltage signal from the energy transmission device to be put into operation with other energy transmission devices of the system that have already been put into operation, wherein in particular the other energy transmission devices are already in each case synchronized with one another by the algorithm. The system preferably comprises the at least one energy reception device. However, it is also conceivable for the system to comprise a multiplicity of energy reception devices. By way of example, the energy reception device is in the form of an inductively operated device, a rechargeable-battery-operated device or a rechargeable battery. Each of the multiplicity of energy reception devices is preferably assigned at least one energy transmission device of the system, wherein the energy transmission device is designed to supply the energy reception device with electrical energy in at least one operating state. As an alternative, it is conceivable for all of the energy reception devices of the system to be compatible with all of the energy transmission devices of the system for an energy transmission.

The configuration according to the invention of the system allows advantageously simple and fast synchronization of transmission pauses of multiple energy transmission devices of the system, in particular advantageously independently of any connection between the energy transmission devices. Synchronizing transmission pauses within the system makes it possible to achieve an advantageously reliable data transmission. Synchronizing transmission pauses within the system allows advantageously accurate foreign body identification, in particular undisrupted by interference caused by electromagnetic fields of other energy transmission devices in the vicinity of the energy transmission device. Simultaneous operation of a multiplicity of energy transmission devices of the system in a constricted space, for example in a kitchen, may advantageously be made possible, in particular since foreign bodies may be identified and/or data may be transmitted by the energy transmission devices advantageously at the same time, and thereby unimpacted by voltage signals for transmitting electrical energy to energy reception devices of the system. Transmission pauses of the energy transmission devices of the system may advantageously be synchronized independently of any physical and/or wired connection of the energy transmission devices.

The method according to the invention, the energy transmission device according to the invention and/or the system according to the invention are/is in this case not intended to be restricted to the application and embodiment described above. The method according to the invention, the energy transmission device according to the invention and/or the system according to the invention may in particular have a number of individual elements, components and units and method steps differing from the number mentioned herein to perform one of the operations described herein. In addition, in the ranges of values indicated in this disclosure, values located within the stated limits should be considered to be disclosed and able to be used as desired.

### DRAWINGS

Further advantages will become apparent from the following description of the drawing. The drawings illustrate three exemplary embodiments of the invention.

The drawings, the description and the claims contain numerous features in combination. A person skilled in the art will expediently also consider the features on their own and combine them to form expedient further combinations.

In the figures:

FIG. 1 shows a schematic illustration of a system according to the invention consisting of multiple energy transmission devices according to the invention for performing a method according to the invention for wirelessly transmitting electrical energy to an energy reception device of the system by way of one of the energy transmission devices,

FIG. 2 shows a basic sketch of a circuit diagram of one of the energy transmission devices according to the invention and of the energy reception device,

FIG. 3 shows a schematic illustration of a sequence of the method according to the invention for wirelessly transmitting electrical energy to the energy reception device by way of one of the energy transmission devices according to the invention,

FIG. 4 shows a schematic illustration of two voltage signals from two energy transmission devices synchronized by way of the method according to the invention,

FIG. 5 shows a schematic illustration of a sequence of an alternative configuration of a method according to the invention for wirelessly transmitting electrical energy to an energy reception device by way of an energy transmission device according to the invention,

FIG. 6 shows a schematic illustration of two voltage signals from two energy transmission devices according to the invention, wherein the two voltage signals are overlaid, and

FIG. 7 shows a schematic illustration of two voltage signals from two energy transmission devices synchronized by way of the alternative configuration of the method according to the invention.

### DESCRIPTION OF THE EXEMPLARY EMBODIMENTS

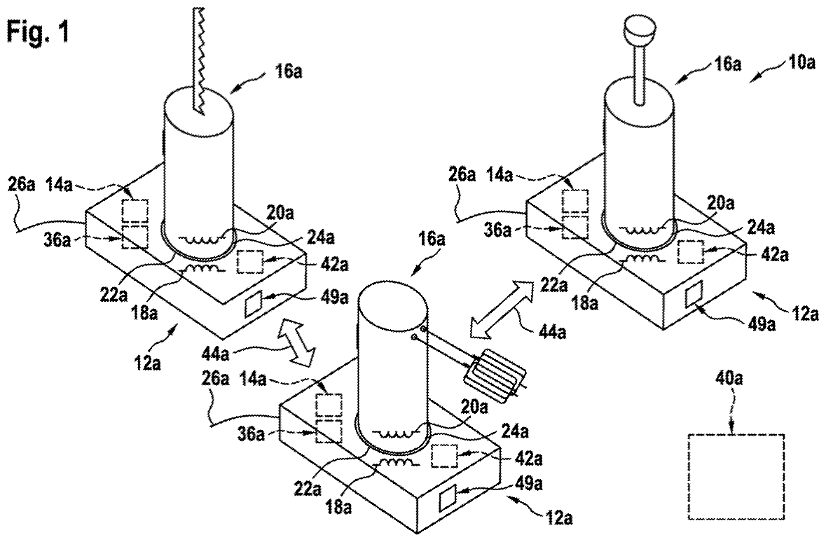

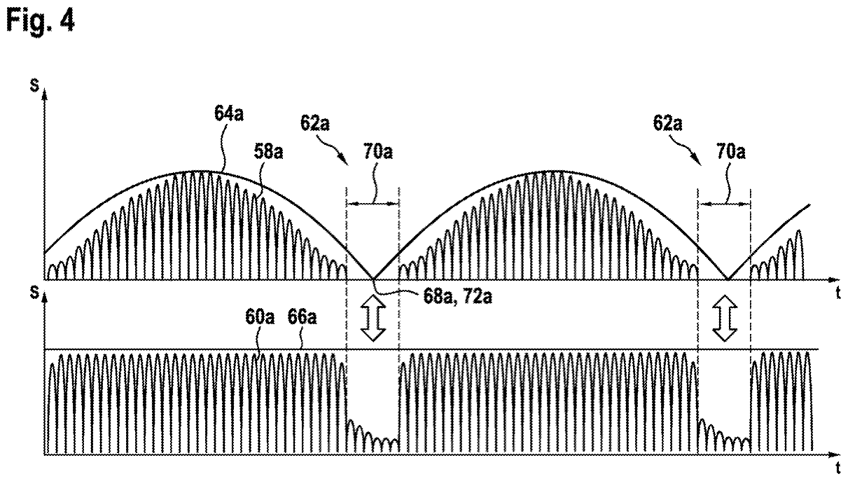

FIG. 1 shows a system 10a consisting of three energy transmission devices 12a, wherein transmission pauses 62a of voltage signals 58a (cf. FIG. 4) of the energy transmission devices 12a are temporally synchronized on the basis of an external reference signal 72a (cf. FIG. 4). The energy transmission devices 12a are each in the form of a smart kitchen device, wherein the energy transmission devices 12a are in particular networked to one another via communication units 14a. Other configurations of the system 10a and/or of the energy transmission devices 12a, independently of the communication units 14a, are however also conceivable. The energy transmission devices 12a are in the form of induction transmission devices, in particular induction chargers. The system 10a preferably comprises three energy reception devices 16a in the form of smart kitchen devices, which are in particular respectively in the form of a rechargeable battery and/or rechargeable-battery-operated device. The energy transmission devices 12a are in particular intended to wirelessly transmit electrical energy to in each case one of the energy reception devices 16a. Each of the energy transmission devices 12a preferably comprises a transmission coil 18a. Each of the energy reception devices 16a in particular comprises a receiver coil 20a. The receiver coil 20a and the transmission coil 18a are preferably designed to be inductively coupled to one another during a transmission process of the energy reception device 16a by way of the energy transmission device 12a. In FIG. 1, the energy reception devices 16a are each arranged on one of the energy transmission devices 12a, wherein in particular a transmission process takes place. The energy transmission devices 12a each comprise at least one device receptacle 22a that is designed to at least partially receive at least one of the energy reception devices 16a in order to transmit electrical energy. The device receptacles 22a, in at least one operating state, in particular during a transmission process, preferably at least partially each define a gap 24a between the energy transmission device 12a and the energy reception device 16a. The transmission coil 18a is in particular arranged in the device receptacle 22a. The system 10a, in particular the individual energy transmission devices 12a, is preferably intended to perform a method 100a for wirelessly transmitting electrical energy to one of the energy reception devices 16a.

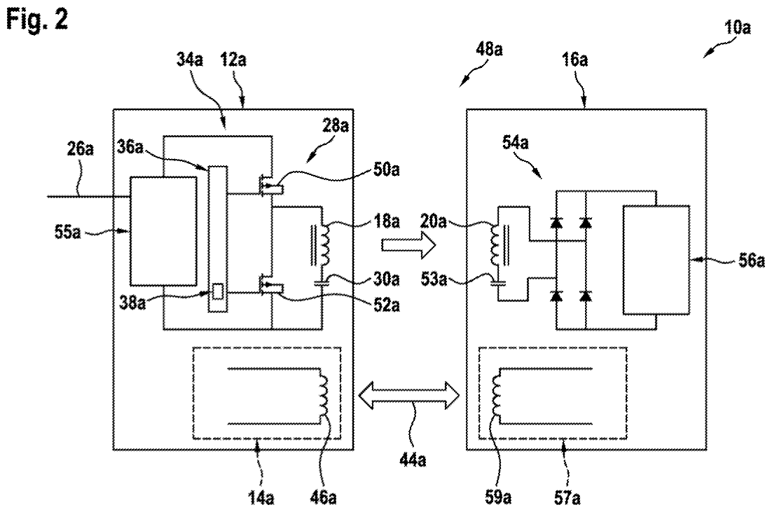

The energy transmission devices 12a are preferably in each case individually electrically connected to a supply grid 26a, wherein the energy transmission devices 12a are operated with a grid voltage 64a (cf. FIG. 4). The energy transmission devices 12a each have an oscillating circuit 28a (cf. FIG. 2), which comprises the transmission coil 18a, a capacitor 30a and an electrical resistor, wherein the electrical resistor is in particular in the form of an electrical resistance of line elements of the oscillating circuit 28a. The energy transmission devices 12a each have a control circuit 34a (cf. FIG. 2) that is intended to excite the oscillating circuit 28a. The oscillating circuit 28a is preferably designed to be excited with the grid voltage 64a by way of the control circuit 34a via a control signal, wherein a voltage signal 58a is in particular generated. The energy transmission devices 12a each have a control and/or regulation unit 36a, which comprises a storage unit 38a (cf. FIG. 2). The energy transmission devices 12a, in particular the oscillating circuits 28a, are in particular each designed to wirelessly transmit energy to the energy reception device 16a using the voltage signal 58a. The oscillating circuit 28a, in particular the transmission coil 18a, preferably generates a magnetic alternating field using the voltage signal 58a, which magnetic alternating field induces a current in the receiver coil 20a of the energy reception device 16a. Electrical energy is in particular transmitted from the energy transmission device 12a to the energy reception device 16a by way of the magnetic alternating field. The energy transmission device 12a, in particular the control and/or regulation unit 36a, is preferably designed to generate the transmission pauses 62a in the voltage signal 58a, in particular at regular time intervals, wherein in particular the transmission pauses 62a of the voltage signal 58a are intended to allow detection of foreign bodies in the gap 24a and/or to allow the energy transmission device 12a to communicate with the energy reception device 16a and/or with an external unit 40a, such as for example a server or a monitoring unit of the system 10a. The energy transmission device 12a, in particular the control and/or regulation unit 36a, is particularly preferably designed to temporally ascertain the at least one time of the transmission pauses 62a of the voltage signal 58a on the basis of the external reference signal 72a, which is in particular independent of the energy reception device 16a. The external reference signal 72a is preferably designed to be independent of the energy transmission unit 12a and the energy reception device 16a, wherein the external reference signal 72a is in particular generated within the supply grid 26a. In the configuration shown in FIG. 1, the external reference signal 72a is in the form of a time of a minimum or of a maximum of the in particular rectified AC voltage of the supply grid 26a of the energy transmission device 12a. The energy transmission devices 12a are particularly preferably designed to synchronize the time of the transmission pauses 62a with the respective other energy transmission devices 12a using the external reference signal 72a and/or using the communication unit 14a.

The energy transmission devices 12a each have a detection unit 42a and one of the communication units 14a, which are in particular connected to one of the control and/or regulation units 36a. The communication units 14a are preferably each designed, during the transmission pauses 62a, to transmit electronic data 44a to one of the energy reception devices 16a and/or one of the other energy transmission devices 12a and/or to receive electronic data 44a from one of the energy reception devices 16a and/or one of the other energy transmission devices 12a. By way of example, the communication unit 14a is designed to communicate a state, in particular a state of charge, of the energy reception device 16a to the energy transmission device 12a via the data transmission. As an alternative or in addition, it is conceivable for the communication unit 14a to be designed to communicate a state of the energy reception device 16a and/or of the energy transmission device 12a to the external unit 40a, such as for example a server and/or a monitoring unit, via the data transmission. The communication units 14a are each in the form of an NFC device, wherein the communication units 14a preferably each comprise an NFC communication coil 46a. Other configurations of the communication unit 14a are however also conceivable, for example as a Bluetooth device, as a W-LAN device, as a PLC device or the like. The data transmission preferably takes place in accordance with at least one standard, in particular the QI standard, from the Wireless Power Consortium (WPC). The detection units 42a are in particular each in the form of part of one of the control and/or regulation units 36a and designed to detect foreign bodies in the gap 24a on the basis of a temporal profile of a quality characteristic value of a transmission system 48a consisting of oscillating circuit 28a and energy reception device 16a. The detection units 42a are preferably each intended to ascertain and to evaluate the temporal profile of the quality characteristic value during the transmission pauses 62a. The foreign body identification preferably takes place by way of the detection unit 42a in accordance with at least one standard, in particular the QI standard, from the Wireless Power Consortium (WPC).

All of the energy transmission devices 12a of the system 10a are connected to exactly one external conductor of the supply grid 26a, this in particular not being shown in the figures. However, it is also conceivable for the energy transmission devices 12a each to be connected to more than one external conductor of the supply grid 26a, wherein in particular exactly one of the external conductors is used to ascertain the time of the transmission pauses 62a. All of the energy transmission devices 12a of the system 10a are connected to the same external conductor of the supply grid 26a, wherein in particular the times of the minimum or of the maximum of the AC voltage of the supply grid 26a are the same for all energy transmission devices 12a. The transmission pauses 62a of the voltage signals 58a of the energy transmission devices 12a are preferably synchronized, in particular by the communication units 14a, via an external conductor, used to ascertain the time of the transmission pauses 62a, of the supply grid 26a. It is conceivable for the energy transmission device 12a to comprise an input and/or output unit 49a that is designed for a user to control the energy transmission device 12a, in particular to activate and/or deactivate a calibration mode and/or for a query as to whether a foreign body is in the gap 24a. For example, the input and/or output unit 49a is in the form of a touch display. However, other configurations of the input and/or output unit 49a are conceivable, for example as a keypad, as a microphone or the like.

FIG. 2 shows one of the energy transmission devices 12a and one of the energy reception devices 16a, in particular during a transmission process, in the form of a basic sketch. Circuit diagrams of the energy transmission device 12a and of the energy reception device 16a are illustrated schematically in FIG. 2. The control circuit 34a of the energy transmission device 12a has at least one driver element 50a and at least one further driver element 52a. However, it is also conceivable for the control circuit 34a to comprise just one driver element 50a, 52a. The driver element 50a, in particular in relation to the oscillating circuit 28a, is in the form of a high-side driver and the further driver element 52a, in particular in relation to the oscillating circuit 28a, is in the form of a low-side driver. The driver element 50a and/or the further driver element 52a are/is in the form of one or more metal oxide semiconductor field-effect transistors, in particular so-called MOSFETs. However, other configurations of the driver element 50a and/or the further driver element 52a are also conceivable, for example as one or more insulated-gate bipolar transistors, in particular so-called IGBTs. The control circuit 34a is electrically connected to the control and/or regulation unit 36a and the oscillating circuit 28a. The energy transmission devices 12a in particular each have a rectifier 55a for rectifying the AC voltage of the supply grid 26a, wherein the rectifier 55a is in particular electrically connected to the control circuit 34a and is connected to the supply grid 26a. The rectified AC voltage is preferably present at the driver element 50a and the further driver element 52a, wherein the oscillating circuit 28a is excited by the rectified AC voltage in the event of switching of the driver element 50a, in particular by way of the control and/or regulation unit 36a. The NFC communication coil 46a of the communication unit 14a of the energy transmission device 12a is shown schematically in FIG. 2. It is conceivable for the communication unit 14a, in particular the NFC communication coil 46a, to be electrically connected to the control and/or regulation unit 36a. The energy reception device 16a comprises the receiver coil 20a, a capacitor 53a, a rectifier 54a, which is in particular formed of four diodes, and an energy storage unit 56a, for example a rechargeable battery cell. The energy reception device 16a in particular comprises at least one communication unit 57a, which in particular comprises an NFC communication coil 59a for data transmission with the communication coil 46a of the communication unit 14a of the energy transmission device 12a. The rectifier 54a is designed to convert an AC voltage generated by way of the AC current induced by the magnetic alternating field into a DC voltage, which is in particular present at the energy storage unit 56a. However, other configurations of the energy transmission device 12a and/or of the energy reception device 16a are also conceivable. By way of example, it is conceivable for the energy reception device 16a, instead of or in addition to the energy storage unit 56a, to comprise an energy consumption unit, such as for example a motor, a display or the like, which is in particular operated by way of the transmitted electrical energy.

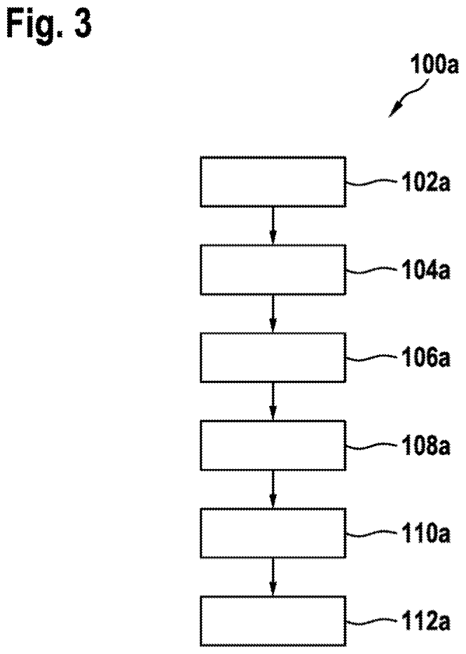

FIG. 3 shows an exemplary sequence of the method 100a for wirelessly transmitting electrical energy to one of the energy reception devices 16a by way of one of the energy transmission devices 12a. In at least one method step 102a of the method 100a, electrical energy is wirelessly transmitted to the energy reception device 16a by way of the oscillating circuit 28a of the energy transmission device 12a using the voltage signal 58a. In at least one further method step 104a of the method 100a, in particular at regular time intervals, transmission pauses 62a of the voltage signal 68a take place in order to detect foreign bodies and/or to allow the energy transmission device 12a to communicate with the energy reception device 16a and/or with the external unit 40a. In particular, in at least one method step of the method 100a, in particular method step 104a, the repetition rate of the transmission pauses 62a is determined by way of the control and/or regulation unit 36a, in particular on the basis of the grid voltage 64a, the energy transmission device 12a and/or the energy reception device 16a. It is conceivable for the repetition rate of the transmission pauses 62a to be kept constant by way of the control and/or regulation unit 36a during a transmission process. At least one foreign object identification is preferably performed during the transmission pauses 62a by way of the energy transmission device 12a, in particular the detection unit 42a of the energy transmission device 12a. At least one data transmission preferably takes place between the energy transmission device 12a and the energy reception device 16a and/or the external unit 40a during the transmission pauses 62a by way of the energy transmission device 12a, in particular the communication unit 14a of the energy transmission device 12a.

In at least one further method step 106a of the method 100a, at least one time of the transmission pauses 62a of the voltage signal 58a is temporally ascertained on the basis of the at least one external reference signal 72a, which is in particular independent of the energy reception device 16a, by way of the control and/or regulation unit 36a of the energy transmission device 12a. The external reference signal 72a is in the form of a time of a minimum or of a maximum of the in particular rectified AC voltage of the supply grid 26a of the energy transmission device 12a. Preferably, the time of the transmission pauses 62a is temporally ascertained before a beginning of a transmission process and/or during a transmission process of the energy reception device 16a. The time of the transmission pauses 62a of the voltage signal 58a is preferably ascertained on the basis of the at least one time of the minimum or of the maximum of the in particular rectified AC voltage. The AC voltage is in particular rectified in at least one method step of the method 100a, in particular method step 106a, by way of the rectifier 55a of the energy transmission device 12a, wherein the minimum of the rectified AC voltage is in the form of a zero crossing of the AC voltage of the supply grid 26a. In at least one method step of the method 100a, in particular method step 106a, exactly one external conductor, in particular one phase, of the supply grid 26a is preferably selected by way of the control and/or regulation unit 36a for ascertaining the time of the transmission pauses 62a and for exciting the oscillating circuit 28a and/or predefined for ascertaining the time of the transmission pauses 62a and for exciting the oscillating circuit 28a when the energy transmission device 12a is manufactured.

In at least one further method step 108a of the method 100a, the voltage signal 58a is adapted on the basis of the ascertained time of the transmission pauses 62a by way of the control and/or regulation unit 36a. The voltage signal 58a is preferably adapted such that the voltage signal 58a is suspended, interrupted and/or throttled at the ascertained time of the transmission pauses 62a, wherein in particular an amplitude of the voltage signal 58a in the transmission pauses 62a is reduced in comparison with a transmission process outside the transmission pauses 62a. In particular, at the ascertained time of the transmission pauses 62a, an energy transfer from the energy transmission device 12a to the energy reception device 16a is at least substantially suspended. By way of example, at the ascertained time of the transmission pauses 62a, excitation of the oscillating circuit 28a by the control circuit 34a is suspended by way of the control and/or regulation unit 36a. As an alternative or in addition, it is conceivable for the oscillating circuit 28a to be damped at the ascertained time of the transmission pauses 62a, in particular by introducing an electrical resistance into the oscillating circuit 28a. The voltage signal 58a is preferably adapted by way of the control and/or regulation unit 36a such that the transmission pauses 62a temporally comprise the time of the minimum of the AC voltage of the supply grid 26a, in particular the grid voltage 64a, of the energy transmission device 12a. The voltage signal 58a is in particular adapted by way of the control and/or regulation unit 36a such that the time of the minimum of the AC voltage is arranged temporally at least substantially centrally within the ascertained time of the transmission pauses 62a, wherein in particular the time of the minimum is temporally arranged in particular at least 40%, preferably at least 45% and particularly preferably at least 48% of an overall duration of the transmission pauses 62a in each case after a beginning of the transmission pauses 62a. The voltage signal 58a is preferably adapted by way of the control and/or regulation unit 36a such that the time of the minimum is temporally arranged in particular at least 40%, preferably at least 45% and particularly preferably at least 48% of an overall duration of the transmission pauses 62a in each case before an end of the transmission pauses 62a.

In at least one further method step 110a of the method 100a, at least one temporal profile of the external reference signal 72a is detected and processed by way of the control and/or regulation unit 36a in order to ascertain the time of the transmission pauses 62a of the voltage signal 58a. The temporal profile of the external reference signal 72a is preferably detected by way of the control and/or regulation unit 36a using at least one signal characteristic variable, in particular an amplitude, a frequency and/or a wavelength, of the voltage signal 58a, wherein the external reference signal 72a in particular influences the signal characteristic variable of the voltage signal 58a. The signal characteristic variable is preferably detected and plotted over at least one time interval in order to ascertain the temporal profile of the external signal 72a. Particularly preferably, the time interval is in the form of one of the transmission pauses 62a of the voltage signal 58a. As an alternative or in addition, it is conceivable for the temporal profile of the external reference signal 72a to be detected by way of at least one sensor unit of the energy transmission device 12a and transmitted to the control and/or regulation unit 36a. It is conceivable for the external reference signal 72a to be detected preferably directly by the control and/or regulation unit 36a, wherein in particular the grid voltage 64a present at the energy transmission device 12a, in particular at the control and/or regulation unit 36a, is detected. The temporal profile of the external reference signal 72a for ascertaining the time of the transmission pauses 62a of the voltage signal 58a particularly preferably comprises at least one period length of the external reference signal 72a. Preferably, when processing the temporal profile in order to ascertain the time of the transmission pauses 62a of the voltage signal 58a, at least one time of a minimum of the temporal profile is determined by way of the control and/or regulation unit 36a. The voltage signal 58a is in particular adapted by way of the control and/or regulation unit 36a such that the transmission pauses 62a temporally comprise the time of the minimum of the temporal profile of the external reference signal 72a.

In at least one further method step 112a of the method 100a, the ascertained time of the transmission pauses 62a of the voltage signal 58a is synchronized with the external unit 40a or another energy transmission device 12a of the system 10a by way of the communication unit 14a. The energy transmission device 12a is preferably synchronized with the external unit 40a or the other energy transmission device 12a of the system 10a via NFC, Bluetooth, W-LAN, PLC or the like. In particular, in at least one method step of the method 100a, preferably method step 112a, a communication request is output to external units 40a located in the vicinity of the energy transmission device 12a or other energy transmission devices 12a of the system 10a, by way of the communication unit 14a, in particular periodically or continuously, in particular in order to synchronize transmission pauses 62a. Preferably, in order to synchronize the energy transmission device 12a with the external unit 40a or the other energy transmission device 12a of the system 10a by way of the communication unit 14a, a duration 70a (cf. FIG. 4) and the repetition rate of the transmission pauses 62a of the voltage signal 58a are transmitted to the external unit 40a or the other energy transmission device 12a of the system 10a. In particular, in method step 112a of the method 100a, an external conductor, connected to the energy transmission device 12a and/or used to ascertain the time of the transmission pauses 62a of the voltage signal 58a, of the supply grid 26a is preferably transmitted to the external unit 40a or the other energy transmission device 12a of the system 10a by way of the communication unit 14a in order to synchronize the energy transmission device 12a with the external unit 40a or the other energy transmission device 12a of the system 10a. In particular, in method step 112a of the method 100a, transmission pauses 62a of the other energy transmission device 12a of the system 10a and of the energy transmission device 12a are synchronized by the communication unit 14a.

FIG. 4 shows a schematic illustration of a temporal profile of two voltage signals 58a, 60a from two energy transmission devices 12a of different design. The two energy transmission devices 12a are supplied in particular via different grid voltages 64a, 66a. In particular, a first energy transmission device 12a is operated with a grid voltage 64a in the form of an AC voltage and a second energy transmission device 12a is operated with a grid voltage 66a in the form of a DC voltage. The voltage signals 58a, 60a, in particular the frequency of the voltage signals 58a, 60a, are shown schematically in FIG. 4 and have an abstract relationship in relation to the transmission pauses 62a and the grid voltages 64a, 66a of the supply grids 26a of the energy transmission devices 12a in order to clarify the illustration. A time is in particular plotted on the abscissas shown in FIG. 4. A signal strength is preferably plotted on the ordinates shown in FIG. 4. The repetition rate of the transmission pauses 62a preferably corresponds to a value from a range of values of in particular 40 Hz to 200 Hz, preferably 60 Hz to 150 Hz and particularly preferably 100 Hz to 120 Hz. The voltage signals 58a, 60a preferably have a frequency that corresponds in particular to at least 1 kHz, preferably at least 10 kHz and particularly preferably at least 80 kHz. The grid voltage 64a, in the form of an AC voltage, preferably has a frequency that corresponds to a value from a range of values of in particular 20 Hz to 100 Hz, preferably 30 Hz to 75 Hz and particularly preferably 50 Hz to 60 Hz. The time of the transmission pauses 62a of the voltage signal 58a of the first energy transmission device 12a is ascertained by way of the method 100a described in FIG. 3. The time of the transmission pauses 62a of the voltage signal 58a of the first energy transmission device 12a comprises a time of a minimum 68a of the rectified grid voltage 64a, in the form of an AC voltage, of the supply grid 26a. Particularly preferably, the time of the transmission pauses 62a of the voltage signal 60a of the second energy transmission device 12a is synchronized with the first energy transmission device 12a, wherein in particular the time of the transmission pauses 62a of the voltage signal 58a of the first energy transmission device 12a corresponds to the time of the transmission pauses 62a of the voltage signal 60a of the second energy transmission device 12a. Synchronizing the times of the transmission pauses 62a preferably at least substantially prevents mutual influencing of the voltage signals 58a, 60a during the transmission pauses 62a. The duration 70a of the transmission pauses 62a in particular corresponds to a value from a range of values of in particular 0.1 ms to 3 ms, preferably 0.5 ms to 2 ms and particularly preferably 1 ms to 1.5 ms, particularly advantageously preferably of 1.2 ms. It is conceivable for the duration 70a of the transmission pauses 62a of the first energy transmission device 12a and the second energy transmission device 12a to be equalized in the synchronization, in particular by way of control and/or regulation units 36a of the first energy transmission device 12a and the second energy transmission device 12a.

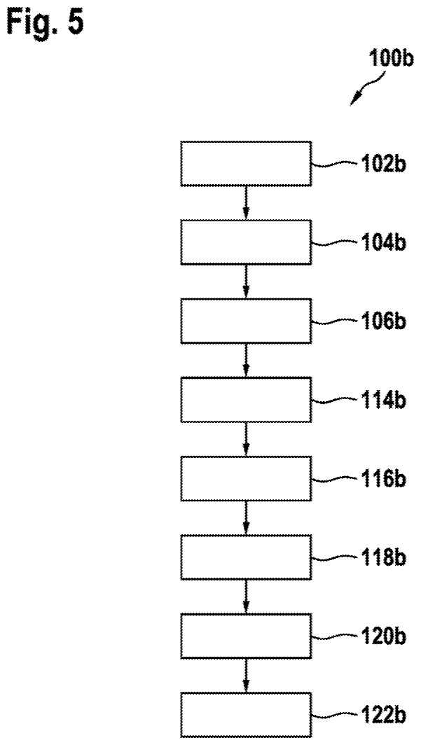

FIGS. 5 to 7 show a further exemplary embodiment of the invention. The following description and the drawings are restricted essentially to the differences between the exemplary embodiments, wherein reference may basically also be made to the drawings and/or the description of the other exemplary embodiments, in particular of FIGS. 1 to 4, with regard to components with the same designation. In order to distinguish between the exemplary embodiments, the letter a has been placed after the reference signs in the exemplary embodiment in FIGS. 1 to 4. In the exemplary embodiments of FIGS. 5 to 7, the letter a has been replaced by the letter b.

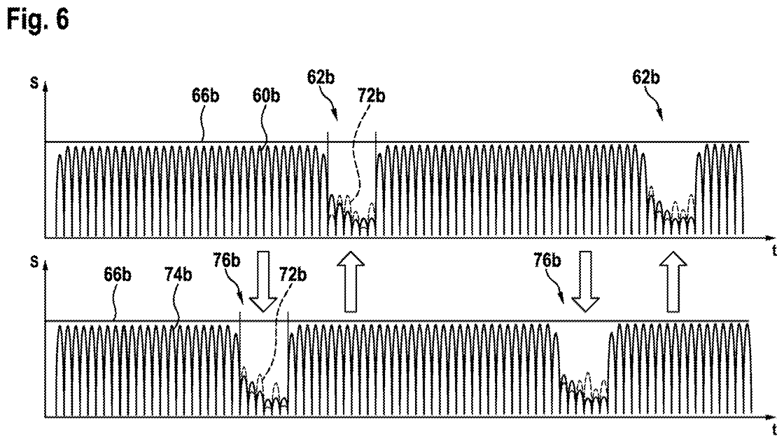

FIG. 5 shows an exemplary sequence of an alternative configuration of a method 100b for wirelessly transmitting electrical energy to an energy reception device 16b by way of an energy transmission device 12b. In at least one method step 102b of the method 100b, electrical energy is wirelessly transmitted to the energy reception device 16b by way of at least one oscillating circuit 28b of the energy transmission device 12b using at least one voltage signal 60b. In at least one further method step 104b of the method 100b, in particular at regular time intervals, transmission pauses 62b of the voltage signal 60b take place in order to detect foreign bodies and/or to allow the energy transmission device 12b to communicate with the energy reception device 16b and/or with an external unit 40b. In at least one further method step 106b of the method 100b, at least one time of the transmission pauses 62b of the voltage signal 60b is temporally ascertained on the basis of at least one external reference signal 72b, which is in particular independent of the energy reception device 16b, by way of at least one control and/or regulation unit 36b of the energy transmission device 12b (cf. FIG. 6). The method 100b illustrated in FIG. 5 has an at least substantially analogous design to the method 100a described in the description of FIGS. 1 to 4, meaning that reference may be made at least substantially to the description of FIGS. 1 to 4 with regard to a design of the method 100b illustrated in FIG. 5. In contrast to the method 100a described in the description of FIGS. 1 to 4, in the method 100b illustrated in FIG. 5, the external reference signal 72b is preferably in the form of an interference signal that is overlaid on the voltage signal 60b. Particularly preferably, a system 10b and the energy transmission device 12b of the system 10b for performing the method 100b are of an analogous and/or identical form to the system 10a and energy transmission device 12a described in FIGS. 1 to 4. By way of example, the interference signal is in the form of a magnetic alternating field that induces an electric current in the oscillating circuit 28b, in particular when it passes through a transmission coil 18b of the energy transmission device 12b. It is in particular conceivable for the interference signal to be in the form of a signal from another transmission coil of another energy transmission device, wherein electrical energy is in particular transmitted to another energy reception device. A current is preferably induced in the oscillating circuit 28b by the interference signal. Preferably, a signal characteristic variable, in the form of an amplitude, of the voltage signal 60b is changed by the interference signal, in particular during the transmission pauses 62b. Particularly preferably, the interference signal changes a quality characteristic value of the oscillating circuit 28b and/or a transmission system 48b consisting of oscillating circuit 28b and energy reception unit 16b.

In at least one further method step 114b of the method 100b, the external reference signal 72b is detected by way of the control and/or regulation unit 36b during the transmission pauses 62b of the voltage signal 60b. The external reference signal 72b in the form of an interference signal is preferably detected continuously or periodically by way of the control and/or regulation unit 36b during the transmission pauses 62b of the voltage signal 60b and stored in at least one storage unit 38b of the control and/or regulation unit 36b. The external reference signal 72b in the form of an interference signal is preferably detected by evaluating the voltage signal 60b by way of the control and/or regulation unit 36b in terms of changes in the signal characteristic variable or the quality characteristic value of the voltage signal 60b, in particular during the transmission pauses 62b. By way of example, the control and/or regulation unit 36b compares signal characteristic variables or quality characteristic values of the voltage signal 60b in successive transmission pauses 62b in order to identify changes in the voltage signal 60b that are brought about by the interference signal overlaid on the voltage signal 60b.

In at least one further method step 116b of the method 100b, the external reference signal 72b is detected by way of the control and/or regulation unit 36b through a comparison of the voltage signal 60b with at least one reference pattern. The reference pattern is preferably detected in at least one method step of the method 100b, this in particular not being shown in FIG. 5, in particular independently of an interference signal, and stored in the control and/or regulation unit 36b, in particular the storage unit 38b. The reference pattern is preferably in the form of a voltage signal during a transmission pause 62b. It is conceivable for a multiplicity of reference patterns to be stored in the control and/or regulation unit 36b, wherein each reference pattern is assigned at least one state characteristic variable, in particular an electrical energy, a voltage or the like, of the oscillating circuit 28b and/or a duration 70b of the transmission pauses 62b. The reference pattern for the comparison with the voltage signal is preferably selected from the multiplicity of stored reference patterns by way of the control and/or regulation unit 36b on the basis of the duration 70b of the transmission pauses 62b of the voltage signal 60b and/or of the state characteristic variable of the oscillating circuit 28b generating the voltage signal 60b, wherein the duration 70b of the transmission pauses 62b and the state characteristic variable of the oscillating circuit 28b in particular at least substantially match the duration 70b, assigned to the reference pattern, of the transmission pauses 62b and/or the state characteristic variable, assigned to the reference pattern, of the oscillating circuit 28b. If the voltage signal 60b differs from the reference pattern during the transmission pauses 62b, an interference signal is detected, wherein a deviation of the voltage signal 60b from the reference signal is in particular ascertained.

In at least one further method step 118b of the method 100b, the external reference signal 72b is detected by way of the control and/or regulation unit 36b through a comparison of quality characteristic values, determined and/or calculated by way of the control and/or regulation unit 36b, of the oscillating circuit 28b during at least two in particular successive transmission pauses 62b of the voltage signal 60b. The quality characteristic values of the oscillating circuit 28b are preferably compared with one another by way of the control and/or regulation unit 36b in order to ascertain the external reference signal 72b, wherein an interference signal is detected in particular in the event of a temporal change in the quality characteristic value. Particularly preferably, the external reference signal 72b is detected in at least one calibration mode of the energy transmission device 12b, wherein in particular a gap 24b between energy transmission device 12b and energy reception device 16b is free of foreign bodies. It is conceivable for the calibration mode to be activated automatically when the energy transmission device 12b is switched on and/or to be able to be activated by a user of the energy transmission device 12b, wherein a query is preferably made, by way of the control and/or regulation unit 36b and/or by way of an input and/or output unit of the energy transmission device 12b, as to whether the gap 24b is free of foreign bodies. As an alternative or in addition, it is conceivable for a temporal profile of the external reference signal 72b to be detected by way of a quality characteristic value, detected by way of the control and/or regulation unit 36b and/or by way of a sensor unit of the energy transmission device 12b, this in particular not being shown in the figures, of the oscillating circuit 28b and/or of the transmission system 48b consisting of oscillating circuit 28b and energy reception device 16b. The transmission pauses 62b are preferably time-shifted in increments in order to detect the temporal profile of the external reference signal 72b and the quality characteristic value is plotted over the time shift of the transmission pauses 62b. During the processing of the temporal profile of the external reference signal 72b in order to ascertain the time of the transmission pauses 62b of the voltage signal 60b, at least one time of a maximum of the temporal profile of the quality characteristic value is preferably determined by way of the control and/or regulation unit 36b using the quality characteristic value. The voltage signal 60b is in particular adapted by way of the control and/or regulation unit 36b such that the transmission pauses 62b temporally comprise the time of the maximum of the temporal profile of the quality characteristic value.

In at least one further method step 120b of the method 100b, the voltage signal 60b is adapted, in particular time-shifted, by way of the control and/or regulation unit 36b, in particular using at least one algorithm, such that the time of the transmission pauses 62b of the voltage signal 60b corresponds at least substantially to a time of a minimum of the interference signal. The algorithm is preferably executed at least by way of the control and/or regulation unit 36b. The transmission pauses 62b are preferably time-shifted in increments by way of the algorithm and a characteristic variable of the voltage signal 60b, in the form of a deviation of the voltage signal 60b from the reference signal, is detected, in particular by the control and/or regulation unit 36b. Preferably, following a time shift of the transmission pauses 60b, which time shift corresponds to at least one period duration of the voltage signal 60b, the characteristic variable of the voltage signal 60b is plotted following the time shift of the transmission pauses 62b by way of the algorithm, wherein at least one minimum of the characteristic variable of the voltage signal 60b is in particular ascertained by way of the control and/or regulation unit 36b. The voltage signal 60b is preferably adapted by way of the control and/or regulation unit 36b such that the transmission pauses 62b comprise a time of the minimum of the characteristic variable of the voltage signal 60b.

In at least one further method step 122b of the method 100b, the ascertained time of the transmission pauses 62b of the voltage signal 60b is synchronized with at least one external unit 40b, in particular another energy transmission device 12b, by way of at least one communication unit 14b of the energy transmission device 12b. Preferably, in at least one method step of the method 100b, in particular method step 122b, in particular after the minimum of the characteristic variable of the voltage signal 60b has been determined by the algorithm, at least one synchronization signal is output to at least one further energy transmission device 12b in the vicinity of the energy transmission device 12b, preferably by way of a communication unit 14b of the energy transmission device 12b. The communication unit 14b is preferably designed to convey the ascertained time of the transmission pauses 62b to the further energy transmission device 12b using the synchronization signal and/or to signal an end of a run-through of the algorithm of the energy transmission device 12b. As an alternative or in addition, it is conceivable for the ascertained time of the transmission pauses 62b of the voltage signal 60b to be transmitted to the external unit 40b or the further energy transmission device 12b by way of the communication unit 14b. In particular if the communication unit 14b exchanges electronic data 44b with the further energy transmission device 12b, it is conceivable for transmission pauses 62b of the further energy transmission device 12b and of the energy transmission device 12b to be synchronized by the communication unit 14b, in particular during transmission pauses 62b.

In particular in a use of the method 100b with the system 10b consisting of multiple energy transmission devices 12b, the transmission pauses 62b of the voltage signals 60b of the energy transmission devices 12b are preferably each synchronized by executing the algorithm when each of the energy transmission devices 12b is put into service, wherein the interference signal is in particular preferably in the form of magnetic alternating fields of transmission coils 18b of energy transmission devices 12b that are already in operation at the time of putting into service. The algorithm is in particular designed to synchronize a time of the transmission pauses 62b of the voltage signal 60b of the energy transmission device 12b to be put into operation with other energy transmission devices 12b of the system 10b that have already been put into operation, wherein in particular the other energy transmission devices 12b are already in each case synchronized with one another by the algorithm.

FIG. 6 shows a schematic illustration of a temporal profile of two voltage signals 60b, 74b from two energy transmission devices 12b of different design. The voltage signals 60b, 74b, in particular the frequency of the voltage signals 60b, 74b, are shown schematically in FIG. 6 and have an abstract relationship in relation to transmission pauses 62b, 76b of the voltage signals 60b, 74b and to grid voltages 66b, in the form of DC voltages, of the supply grids 26b of the energy transmission devices 12b in order to clarify the illustration. A time is in particular plotted on the abscissas shown in FIG. 6. A signal strength is preferably plotted on the ordinates shown in FIG. 6. The repetition rate of the transmission pauses 62b, 76b preferably corresponds to a value from a range of values of in particular 40 Hz to 200 Hz, preferably 60 Hz to 150 Hz and particularly preferably 100 Hz to 120 Hz. The voltage signals 60b, 74b preferably have a frequency that corresponds in particular to at least 1 kHz, preferably at least 10 kHz and particularly preferably at least 80 kHz. A first energy transmission device 12b is operated with the grid voltage 66b, in the form of a DC voltage, of the supply grid 26b. A second energy transmission device 12b is operated with the grid voltage 66b in the form of a DC voltage. The time of the transmission pauses 62b of the voltage signal 60b from the first energy transmission device 12b differs from the time of the transmission pauses 76b of the voltage signal 74b from the second energy transmission device 12b. During the transmission pauses 62b of the first energy transmission device 12b, the voltage signal 60b of the first energy transmission device 12b is influenced by a magnetic alternating field generated by the voltage signal 74b of the second energy transmission device 12b by way of the transmission coil 18b, wherein in particular an amplitude of the voltage signal 60b of the first energy transmission device 12b is changed. Changing the amplitude of the voltage signal 60b of the first energy transmission device 12b during the transmission pauses 60b in particular disrupts, interrupts and/or influences the identification of foreign bodies and/or the transmission of data by the first energy transmission device 12b. The change in the amplitude of the voltage signal 60b of the first energy transmission device 12b is the external reference signal 72b in the form of an interference signal, which is used, in particular in the method 100b, to ascertain the time of the transmission pauses 62b of the voltage signal 60b.

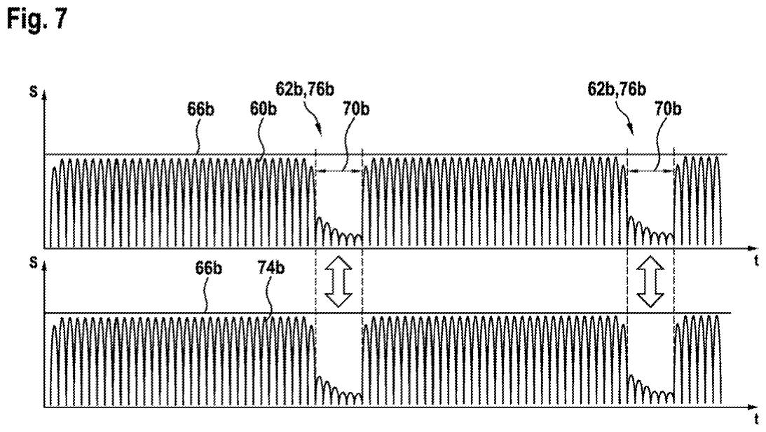

FIG. 7 shows a schematic illustration of a temporal profile of two voltage signals 60b, 74b from two energy transmission devices 12b of different design. The two energy transmission devices 12b are in particular of identical form to the two energy transmission devices 12b whose voltage signals 60b, 74b are shown in FIG. 6. A time is in particular plotted on the abscissas shown in FIG. 7. A signal strength is preferably plotted on the ordinates shown in FIG. 7. In the temporal profile of the two voltage signals 60b, 74b shown in FIG. 7, the transmission pauses 62b, 76b of the two voltage signals 60b, 74b are synchronized, in particular by way of the external reference signal 72b, preferably by way of the method 100b, wherein in particular the time of the transmission pauses 62b of the voltage signal 60b of the first energy transmission device 12b corresponds to the time of the transmission pauses 76b of the voltage signal 74b of the second energy transmission device 12b. Synchronizing the times of the transmission pauses 62b, 76b preferably at least substantially prevents mutual influencing of the voltage signals 60b, 74b during the transmission pauses 62b, 76b. A duration 70b of the transmission pauses 62b, 76b in particular corresponds to a value from a range of values of in particular 0.1 ms to ms, preferably 0.5 ms to 2 ms and particularly preferably 1 ms to 1.5 ms, particularly advantageously of 1.2 ms. It is conceivable for the duration 70b of the transmission pauses 62b, 76b of the first energy transmission device 12b and of the second energy transmission device 12b to be equalized in the synchronization, in particular by way of control and/or regulation units 36b of the first energy transmission device 12b and the second energy transmission device 12b. The voltage signals 60b, 74b shown in FIG. 7, following the synchronization, are in particular at least substantially in a form free from external reference signals in the form of an interference signal, wherein in particular mutual influencing of the voltage signals 60b, 74b during the transmission pauses 62b, 76b is at least substantially prevented, in particular by a reduced amplitude of the voltage signals 60b, 74b during the transmission pauses 62b, 76b in comparison with between the transmission pauses 62b, 76b.

1. A method for wirelessly transmitting electrical energy to an energy reception device using at least one energy transmission device, comprising:
wirelessly transmitting electrical energy to the energy reception device by way of at least one oscillating circuit of the at least one energy transmission device using at least one voltage signal;
pausing the transmission of the at least one voltage signal, at regular time intervals, to detect foreign bodies and/or to allow the at least one energy transmission device to communicate with the energy reception device and/or with an external unit; and
temporarily ascertaining at least one time of the transmission pauses of the at least one voltage signal based on at least one external reference signal independent of the energy reception device using at least one control and/or regulation unit of the at least one energy transmission device.

2. The method as claimed in claim 1, further comprising:
adapting the at least one voltage signal based on the ascertained at least one time of the transmission pauses using the at least one control and/or regulation unit.

3. The method as claimed in claim 1, further comprising:
detecting and processing at least one temporal profile of the at least one external reference signal by way of the at least one control and/or regulation unit to ascertain the at least one time of the transmission pauses of the at least one voltage signal.

4. The method as claimed in claim 1, wherein the at least one external reference signal is based on a time of a minimum or of a maximum of an AC voltage of a supply grid of the at least one energy transmission device.

5. The method as claimed in claim 1, wherein the at least one external reference signal is based on an interference signal that is overlaid on the at least one voltage signal.

6. The method as claimed in claim 5, further comprising:
detecting the at least one external reference signal using the at least one control and/or regulation unit during the transmission pauses of the at least one voltage signal.

7. The method as claimed in claim 6, further comprising:
detecting the at least one external reference signal by way of the at least one control and/or regulation unit through a comparison of the at least one voltage signal with at least one reference pattern.

8. The method as claimed in claim 6, further comprising:
detecting the at least one external reference signal by way of the at least one control and/or regulation unit through a comparison of quality characteristic values, determined and/or calculated by way of the at least one control and/or regulation unit, of the at least one oscillating circuit during at least two successive transmission pauses of the at least one voltage signal.

9. The method as claimed in claim 5, further comprising:
adapting the at least one voltage signal by way of the at least one control and/or regulation unit using at least one algorithm, such that the time of the transmission pauses of the at least one voltage signal corresponds at least substantially to a time of a minimum of the interference signal.

10. The method as claimed in claim 1, further comprising:
synchronizing the ascertained time of the transmission pauses of the at least one voltage signal with at least one external unit by way of at least one communication unit of the at least one energy transmission device.

11. The method as claimed in claim 1, wherein the method is performed by the at least one energy transmission device for wirelessly transmitting electrical energy to the energy reception device in order to charge a rechargeable battery.

12. A system comprising:
at least one energy transmission device including at least one oscillating circuit and at least one control and/or regulation unit, the at least one energy transmission device configured to wirelessly transmit electrical energy to an energy reception device by:
wirelessly transmitting electrical energy to the energy reception device by way of the at least one oscillating circuit using at least one voltage signal;
pausing the transmission of the at least one voltage signal, at regular time intervals, to detect foreign bodies and/or to allow the at least one energy transmission device to communicate with the energy reception device and/or with an external unit; and
temporarily ascertaining at least one time of the transmission pauses of the at least one voltage signal based on at least one external reference signal independent of the energy reception device using the at least one control and/or regulation unit,
wherein the transmission pauses of the at least one voltage signal of the at least one energy transmission device are temporally synchronized based on at least one external reference signal.
